(19) United States
(12) Patent Application Publication
(10) Pub. No.: US 2009/0143257 A1
(43) Pub. Date: Jun. 4, 2009

(54) Methods and Compositions for Controlling Water Production

(76) Inventors: Ling Kong Teng, Segamat (MY); Keng Seng Chan, Kuala Lumpur (MY); Suzylawati Ismail, Petaling Jaya (MY); Mathew Samuel, Sugar Land, TX (US); Jay Russell, Issy-les-Moulineaux (FR); Trevor Lloyd Hughes, Cambridge (GB)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 12/030,273

(22) Filed: Feb. 13, 2008

(30) Foreign Application Priority Data
Dec. 3, 2007 (MY) PI 20072153

(51) Int. Cl. C09K 8/00

(52) U.S. Cl. 507/219

(57) ABSTRACT

A composition for treatment of a subterranean formation, which may be used for water control, is comprised of at least one of 1) a premix of an oleochemical polyol, at least one of polyisocyanate, polycyanate and polyisothiocyanate, and a blocking agent to temporarily block all or a portion of free reactive groups of said at least one of polyisocyanate, polycyanate and polyisothiocyanate. Alternatively, or in addition, the composition may be comprised of a solvent and 2) a polyurethane prepolymer formed by reacting an oleochemical polyol and at least one of polyisocyanate, polycyanate and polyisothiocyanate. A blocking agent may also be used with the polyurethane prepolymer. The composition may be used in a method of treating a subterranean formation penetrated by a wellbore by introducing the composition into the formation through the wellbore. In another embodiment, a method of treating a subterranean formation penetrated by a wellbore is carried out by forming a treatment fluid containing at least one of 1) palmitic acid or its derivatives and 2) palm oil and at least one of an hydrolyzing or oxidizing agent to facilitate formation of palmitic acid or its derivatives. The treatment fluid also includes a source of a monovalent ions. The treatment fluid is introduced into the wellbore for treatment of the subterranean formation.

### CROSS-REFERENCE TO RELATED APPLICATION

The present document is based on and claims priority to Malaysian Application Serial No: PI 20072153 filed on Dec. 3, 2007.

### BACKGROUND

The production of water and aqueous fluids from oil and gas wells is a common phenomenon that may pose a variety of problems. Water production typically acts to reduce the amount of oil and gas that may ultimately be recovered from a well, as the increase in volume of water or aqueous fluids limits the amount of hydrocarbons that can be produced. It has been estimated that more than 250 million barrels of unwanted water is produced every day in oil and gas production and exploration. This is about three times the volume of oil that is produced. The production of water may increase the cost and size of the equipment required to separate the water from the produced hydrocarbons. As the fields become mature, the amount of water produced tends to increase, sometimes to the point where surface handling systems become overloaded. Water production may also cause the formation of unwanted emulsions and cause scaling in tubing and other equipment. All of this impacts the productivity of the well, and thus affects the well's profitability.

Modern field evaluation techniques combined with water management can improve productivity and thus field economics. One of the most important tools in water management is downhole water shutoff either by chemical or mechanical methods. Reducing water production in mature fields is not straightforward, however. In some cases, treatments using the current non-selective water shutoff systems can provide an adequate solution but, in many cases, there is a clear need for treatments which can selectively shutoff water without affecting flow from the hydrocarbon producing zones. Indeed, there is a growing need for selective shut-off treatments which can preferentially shut down the flow from watered out zones while not affecting the flow from the hydrocarbon producing zones.

Current methods for water shutoff include the use of inorganic gels (e.g. sodium silicates, alumina gel, etc.), polymers (e.g. polyacrylamides), resins (e.g. urea-formaldehydes, phenol-formaldehydes, furfuryl, polyvinyl, epoxy, etc.), latex (e.g. styrene-butadiene complex). Most of these products can be injected into the formation pores and, after placement and gelation/curing, they can provide a sufficient resistance to fluid flow. This resistance can be achieved in pores, fractures, vugs and perforations. Most of these water shutoff systems are robust under downhole conditions and therefore they can provide long-term sealing if properly placed. Such materials can be relatively costly, however, and are therefore often pumped in rather small volumes to cover rather short penetration depths (such as the first few radial feet from a wellbore). Zonal isolation is typically required for non-selective water shutoff treatments but some unwanted migration of the fluid into adjacent hydrocarbon producing zones can occur. Another drawback in the use of these materials is that the treatment may need to be repeated as the resistance to flow may deteriorate with time. Additionally, such remedial treatments with these materials may not be very effective.

In an ideal situation, a treatment using a relative permeability modifier (RPM) reduces water permeability much more than oil permeability and does not require zonal isolation. Earlier studies have demonstrated that simple linear polymers such as polyacrylamide and polysaccharides can absorb on rock surfaces and can cause disproportionate permeability differences in water and hydrocarbon bearing zones. Most of the RPMs that are available commercially are either amphoteric polymeric material or hydrophilic polyacrylamide-based ter-polymer. Although RPMs are designed for the selective shutoff of water zones without affecting the oil zones, the evidence from field treatments suggests a widely variable performance.

In general, the current methods for water shutoff are largely based on non-renewable materials. Therefore, there is a benefit in developing water shutoff systems which are based on materials derived from renewable resources.

Because of the shortcomings of these various methods, new methods and improvements for controlling the production of water from subterranean formations in oil and gas wells are needed.

### SUMMARY

The present invention is directed toward a method of treating a subterranean formation penetrated by a wellbore. The method involves forming a treatment fluid of a solvent containing of an oleochemical polyol, at least one of polyisocyanate, polycyanate and polyisothiocyanate, and a blocking agent to temporarily block all or a portion of free reactive groups of said at least one of polyisocyanate, polycyanate and polyisothiocyanate. Alternatively, or in addition, the solvent may contain a polyurethane prepolymer formed by reacting an oleochemical polyol and at least one of polyisocyanate, polycyanate and polyisothiocyanate. The treatment fluid is introduced into the wellbore to effect treatment of the subterranean formation.

The invention also provides a composition for treatment of a subterranean formation for water control. The composition may include a solvent and an oleochemical polyol, at least one of polyisocyanate, polycyanate and polyisothiocyanate, and a blocking agent to temporarily block all or a portion of free reactive groups of said at least one of polyisocyanate, polycyanate and polyisothiocyanate. Alternatively, or in addition, the composition may include a solvent and a polyurethane prepolymer dispersed within the solvent, wherein the polyurethane prepolymer is formed by reacting an oleochemical polyol and at least one of polyisocyanate, polycyanate and polyisothiocyanate.

In another embodiment of the invention, a method of treating a subterranean formation penetrated by a wellbore is carried out by forming a treatment fluid containing at least one of 1) palmitic acid or its derivatives and 2) palm oil and at least one of an hydrolyzing or oxidizing agent to facilitate formation of palmitic acid or its derivatives. A source of a monovalent ion is also included in the treatment fluid. The treatment fluid is introduced into the wellbore.

### BRIEF DESCRIPTION OF THE DRAWINGS

For a more complete understanding of the present invention, and the advantages thereof, reference is now made to the following descriptions taken in conjunction with the accompanying figures, in which:

FIG. 1 is a photo of a pre-gelled polyurethane prepolymer formed during synthesis of the polyurethane prepolymer;

FIG. 2 is a plot of Fourier Transform Infrared Spectra (FTIR) for a polyurethane prepolymer and those starting materials used in forming the polyurethane prepolymer;

FIG. 3 is a photo of gelled polyurethane prepolymer after contact with an aqueous brine solution;

FIG. 4 is a photo of a polyurethane prepolymer in solution with mineral spirits, demonstrating that the prepolymer remains ungelled and flowable in such solution;

FIG. 5 is a plot of the curing time of gelled polyurethane prepolymer versus temperature;

FIG. 6 is a plot of the injectivity rates of brine at different pressures and a non-blocked treatment fluid (TF1) at a given pressure over time in a sandstone core sample (T1);

FIG. 7 is a plot of the injectivity rates of brine at different pressures and a blocked premix treatment fluid (TF2) at a given pressure over time in a sandstone core sample (T2);

FIG. 8 is a plot of the injectivity rates of brine at different pressures and blocked premix treatment fluid (TF3) at a given pressure over time in a sandstone core sample (T3);

FIG. 9 is a plot of the injectivity rates of brine at different pressures and non-blocked treatment fluid (TF4) at a given pressure over time in a sandstone core sample (T4); and

FIG. 10 is a plot of the injectivity rates of brine before and after treatment of sandstone core (T4) with a blocked treatment fluid (TF4) after curing.

### DETAILED DESCRIPTION

Polyurethane is a very versatile material that can be tailored to have a wide range of properties that may be used in a variety of applications. Depending upon the application, the polyurethane can be formulated to be very hard or very soft, to be stiff or rubbery, to have a high density or a low density, etc. The urethane groups do not necessarily constitute the majority of the functional groups within polyurethane, and by incorporating other functional groups into the polymer network, a wide range of properties can be provided. Therefore, polyurethane has been used extensively in making plastic products, adhesives, rigid foams, flexible foams, elastomers, and a variety of other materials.

In their basic form, polyurethane is a polymer formed by reacting monomers containing two or more isocyanate groups (—N═C═O), i.e. a polyisocyanate, with another monomer containing two or more alcohol (—OH) groups, i.e. a polyol. This results in a polymer chain with urethane (—NH(CO)O—) linkages, which is referred to as a polyurethane.

The present invention makes use of similar chemical reactions, but a substantial part of the reactant material is derived from renewable resources, such as those materials from biological fats or oils, such as those from vegetable or animal sources. The biological oils or fats may be further modified to form oleochemical polyols. As used herein, “oleochemical polyols” are those polyols that are derived from biological oils or fats. These polyols may then be prereacted with polyisocyanates to form polyurethane prepolymers that react with water to form an adhesive polyurethane that facilitates selectively blocking or plugging of water producing zones in oil and gas wells. The polyurethane prepolymers do not react with hydrocarbons so that the hydrocarbon producing zones of the subterranean formation are unaffected and will continue to produce. In this way, the subterranean formation can be selectively treated to prevent or reduce water production from water-bearing zones while leaving hydrocarbon-producing zones unaffected. In an alternative or modification to this method, the polyols may be prereacted with polyisocyanates followed by a further reaction to “block” the free isocyanate groups so that they remain inactive until re-activated, such as with increased temperature.

In a further alternative or modification to this method, the oleochemical polyol itself may be combined directly with a blocked polyisocyanate (a polyurethane “premix”) without the formation of a polyurethane prepolymer to result in a treatment fluid which will not react during fluid placement and which will only become reactive when the system is re-activated, such as when the temperature of the fluid reaches the reservoir temperature. As is discussed later on, the blocked isocyanate of the premix is designed to “de-block” at reservoir temperature to thereby release the isocyanate for subsequent reaction with the oleochemical polyol and water to form polyurethane to effectively block or plug the water-bearing zones of the formation.

Although the expressions “fats” and “oils” are both used herein, the oils described herein are generally considered to be fats as well. Where used together, “fats” typically refers to those fats that are generally solid at room temperatures, whereas “oils” may refer to those fats that are generally liquid at room temperatures. The terms may therefore be used interchangeably herein with the term “oil” referring to fats or vice versa.

The biologically-derived oils or fats used in the present invention are composed of triglycerides, which are triesters of glycerol with three carboxylic acids that contain a long aliphatic carbon chains. These long-chain carboxylic acids are typically referred to as “fatty acids.” The length of the carbon chain of the fatty acids may vary typically from about 4 to 30 carbon atoms, although carbon chains of from 6 to 24 carbon atoms are more typical.

The carbon chain of the fatty acids may be saturated or unsaturated. The carbon chains of saturated fatty acids do not contain any carbon-carbon double bonds, while the unsaturated fatty acids contain at least one double bond. The degree of unsaturation of the fatty acids may vary, with some unsaturated fatty acids containing only a single double bond and others containing more than one. Those fatty acids containing one, two or three double bonds are particularly useful.

The most common saturated fatty acids occurring in biologically-derived fats and oils include butyric acid, caproic acid, caprylic acid, capric acid, lauric acid, myristic acid, palmitic acid, stearic acid, arachidic acid, aehenic acid and lignoceric acid. Examples of unsaturated fatty acids include, but are not limited to, linoleic acid, oleic acid, palmitoleic acid, myristoleic acid, alpha-linoleic acid, arachidonic acid, hexadecenoic acid and erucic acid.

Examples of those fats and oils derived from animal matter include butter, lard, tallow, neatsfoot oil, greases or marine oils, such as those from whales (e.g. sperm whale), seals (e.g. gray seal) and fish oils (e.g. herring oil), including fish liver oil. Examples of vegetable fats and oils include palm oil, olive oil, castor oil, soybean oil, almond oil, safflower seed oil, niger seed oil, tobacco seed oil, peanut oil, cottonseed oil, sunflower seed oil, rapeseed oil, linseed oil, tung oil, babassu kernel oil, sesame oil, coconut oil, and corn oil. Such oils and fats are typically made up of a mixture of components and are not necessarily formed from any single component. For example, palm oil may be comprised of a mixture of various fatty acids (saturated and unsaturated), such as palmitic acid, oleic acid, stearic acid, myristic acid, hexadecenoic acid, linoleic acid, etc. Vegetable oils or fats typically contain higher levels of unsaturated fatty acids than do those from animal sources and may therefore be more suitable for use in the invention because they are more readily converted to polyols, as is described further on.

Various methods may be used to form the oleochemical polyols. In one such method, the unsaturated fatty acids in biologically-derived fats or oils may be epoxidized so that they are converted into acyl radicals. These acyl radicals contain a number of epoxy groups corresponding to the original number of olefinic double bonds of the unsaturated fatty acid. The epoxidized triglycerides are reacted with alcohols, which leads to the formation of the polyol. The alcohols used may be monohydric alcohols having a carbon chain length of C₁-C₁₂, more typically those with a chain length of C₁-C₃, such as methanol, ethanol, n-propanol, or isopropanol. In these oleochemical polyols, the fatty acid residues carry a hydroxyl group and an alkoxy group at the positions epoxidized. These groups are introduced during ring opening with the alcohol. Further discussion of the conversion of biologically-derived fats and oils to polyols is described in U.S. Pat. No. 4,742,087, which is incorporated herein by reference in its entirety.

Another method of converting triglycerides to form a polyol derivative involves ozonolysis. In this method the triglycerides are ozonized so that the double bonds of the triglycerides are bonded to oxygen. This is then reduced by zinc or other suitable reducing agent and then hydrogenated to give end-chain hydroxyls. This is described in the article by Kong, X. and Narine, S., Physical Properties of Polyurethane Plastic Sheets Produced from Polyols from Canola Oil, Biomacromolecules, 2007, pages 2203-2209, Vol. 8, No. 7, which is herein incorporated by reference in its entirety.

The polyols may also be formed through known transesterfication processes of the biologically-derived fats or oils. In these methods, the triglycerides may be reacted with glycerol in the presence of a base to form a mixture of mono- and di-glycerides. Polyesters are formed by the polycondensation reaction between the polyfunctional acidand the polyhydroxyl compounds. The polyester compounds eventually are transesterfied with the mixture of mono- and di-glycerides to obtain the polyol. The progress of the reaction can be monitored by the collection of water of the reaction.

Other methods known to those skilled in the art may also be used in preparing the oleochemical polyols.

Particularly suitable are the oleochemical polyols having two or more —OH groups located on adjacent carbon atoms, more particularly are those having from 2 to 6 hydroxyl groups along its carbon chain. The hydroxyl groups react with the isocyanate to form polyurethane. A suitable range for the hydroxyl number of the oleochemical polyols may be from about 100 to about 300 KOH mg/g or higher, more particularly from about 150 to 250 KOH mg/g.

To form the polyurethane prepolymer, the oleochemical polyol may be reacted with an excess of organic polyisocyanates. The reaction may be represented by Equation (1) presented below:

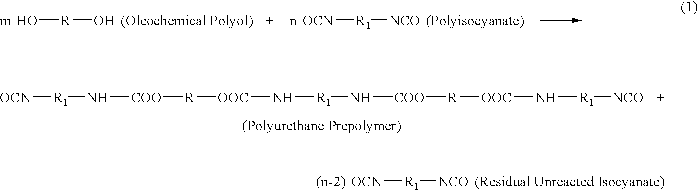

The ratio of isocyanate groups to hydroxyl groups, (n/m), is optimized in order to limit the final molecular weight of the prepolymer and to control the concentration of “free” isocyanate groups of the prepolymer. The final molecular weight of the prepolymer will influence both the viscosity and the injectivity of the treatment fluid. The concentration of “free” isocyanate groups on the prepolymer will influence its reactivity. Typically, the molar ratio (n/m) is varied in the range from about 2 to about 8.

The polyisocyanates are typically diisocyanate compounds, although triisocyanates and other higher polyisocyanates can be used as well. As used herein, the prefix “poly-” is meant to encompass di-, tri- and higher levels of the functional group. Typical aromatic polyisocyanates include 1,3-phenylene diisocyanate, 1,4-phenylene di-isocyanate, 4,4′-diphenyldiisocyanate, 4,4′-diphenylmethane diisocyanate, 2,4-tolylene diisocyanate, 2,6 tolylene diisocyanate, 4,4′-toluidine diisocyanate, dianisidine diisocyanate, 4,4′-diphenylether diisocyanate, 4,4′,4′-triphenylmethane triisocyanate, 1,3,5-triisocyanatobenzene and 2,4,6-triisocyanatotoluene. Typical aliphatic polyisocyanates include trimethylene diisocyanate, tetramethylene diisocyanate, hexamethylene diisocyanate, pentamethylene diisocyanate, 1,2-propylene diisocyanate, 2,3-butylene diisocyanate, 1,3-butylene diisocyanate, 2,4,4- or 2,2,4-trimethylhexamethylene diisocyanate and methyl 2,6-diisocyanatocaproate. Typical aromatic-aliphatic polyisocyanates include ω, ω′-diisocyanato-1,3-dimethylbenzene, ω, ω′-diisocyanato-1,4-dimethylbenzene, ω, ω′-diisocyanato-1,4-diethylbenzene, 1,3-tetramethylxylene diisocyanate and 1,4-tetramethylxylene diisocyanate. Typical alicyclic polyisocyanates include 1,3-cyclopentane diisocyanate, 1,4-cyclopentane diisocyanate, 1,4-cyclohexane diisocyanate, 1,3-cyclohexane diisocyanate, 3-isocyanatomethyl-3,5,5-trimethylcyclohexyl isocyanate, 4,4′-methylenebis-(cyclohexylisocyanate), methyl-2,4-cyclohexane diisocyanate, methyl-2,6-cyclohexane diisocyanate, 1,4-bis(isocyanatomethyl)cyclohexane and 1,3-bis(isocyanatomethyl)cyclohexane. The polyisocyanates may be used individually or as a mixture with other polyisocyanates.

When oleochemical polyols are reacted with polyisocyanates, the polyurethane prepolymer is terminated at each end with isocyanate functional groups (—N═C═O). It is the isocyanate group of the polyurethane prepolymer that reacts with water to form the polyurea used in plugging or blocking off the water-bearing zones. The isocyanate functional group acts as a reactive group. The reaction steps may be represented by the formulas presented in Equations (2), (3) and (4) below:

R₁—NCO+H₂O→[R₁NHCOOH] (2)

[R₁NHCOOH]→R₁NH₂+CO₂ (3)

R₁NH₂+R₁NCO→R₁NHCONHR₁ (4)

wherein, R₁—NCO is the polyurethane prepolymer showing an isocyanate end group. The initial reaction of Equation (2) forms the unstable carbamic acid [R₁NHCOOH]. Loss of carbon dioxide (CO₂) in Equation (3) leads to the formation of the amine R₁NH₂. With excess isocyanate groups available for reaction, the amine R₁NH₂ will react to form the corresponding symmetrically substituted urea, as in Equation (4). This leads to the formation of polyurethane-urea. The formation of urea in the polyurethane may provide a hardness to the final polymer. The final polyurethane polymer has an adequate adhesion to plug or block the water zone. In contrast, the prepolymers will not react with hydrocarbons of the formation and so remain in a liquid phase in solution.

In carrying out the prepolymer formation reaction, the polyisocyanate is provided in a solution wherein a stoichiometric excess of the polyisocyanate may be used. If a stoichiometric excess of polyisocyanate is used, the resulting short diurethane chains formed are —NCO terminated and the product is called NCO-terminated prepolymer. The theoretical NCO (wt %) can range from 3.4 to 17.6. Theoretical NCO (wt %) is the calculated stoichiometric percentage of free NCO groups at the end of synthesis. The NCO/OH molar ratio may range from about 2 to about 8. Differences in the NCO/OH ratio used in converting an oleochemical polyols to a prepolymer may influence the properties of the polyurethane end product. At very high NCO/OH ratios, a high viscosity may result due to crystallization of residual monomeric in the product. The prepolymer average molecular weight may affect the glass transition temperature, particularly when prepolymer has shorter soft segments. With increasing content of polyol with lower molecular weight, the glass transition temperature may increase. At lower NCO/OH ratios, the rigidity of the final polymeric product increases with increasing free NCO content. This may include the rate of urethane group formation, viscosity, stiffness, adhesion, etc. The free isocyanate (NCO) content of the prepolymer may vary from about 3% to about 30% by weight of prepolymer, with from about 3 to about 15% by weight being more typical. As used herein, “free isocyanate” means the isocyanate functional groups of the prepolymer that are free to react to form the polyurethane molecules or react with water to form polyurea. The free isocyanate are typically the end cap isocyanate groups of the prepolymer.

It should be noted that the description and examples are presented solely for the purpose of illustrating the various embodiments of the invention and should not be construed as a limitation to the scope and applicability of the invention. While the compositions of the present invention are described herein as comprising certain materials, it should be understood that the composition could optionally comprise two or more chemically different materials. For example, a polyol material derived from petroleum such as a hydroxyl-terminated polyether or hydroxyl-terminated polyester could be used in a blend with the oleochemical polyol. In addition, the composition can also comprise some components other than the ones already cited. Furthermore, in the description, each numerical value should be read once as modified by the term “about” (unless already expressly so modified), and then read again as not so modified unless otherwise indicated in context. Also, in the summary of the invention and this detailed description, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possession of the entire range and all points within the range.

In selecting the appropriate polyisocyanate for use in forming the polyurethane prepolymers, the polyisocyanate may provide a polyurethane prepolymer that provides a gelation time of about ½ hour to about 24 hours when contacted with water or other aqueous fluid under downhole conditions or conditions were the treatment is to be applied to form the polyurethane. In certain embodiments, the polyurethane prepolymer may provide gelation times of from about ½ hour to about 15 hours, from about 1 hour to about 10 hours, or from about 3 hours to about 10 hours.

Although polyisocyanates are particularly useful in the present invention, other reactants may be used besides polyisocyanates in forming the polyurethane prepolymer and may be selected in a similar manner and used in similar amounts to provide the appropriate gelation time. These may include polycyanates and polyisothiocyanate compounds. The reaction mechanism of these compounds is generally the same as that of polyisocyanates described above. Although polyisocyanates are described at length in this description, it should understood that the other compounds of polycyanates and polyisothiocyanates could be used as well. Accordingly, unless it is otherwise apparent from the context, the term “polyisocyanate” or variations of this term may also be construed to include polycyanate and polyisothiocyanate. The isocyanate, cyanate and isothiocyanate functional groups may each act as “free reactive groups” of the polyurethane prepolymer to facilitate the formation of polyurethane. As used herein, the term “free reactive group” is meant to encompass any one or all of the ions of isocyanate, cyanate and isothiocyanate that are free to react to form the polyurethane molecules. The free reactive groups are typically the end cap isocyanate, cyanate or isothiocyanate groups of the prepolymer. The free reactive group content of the prepolymer may vary from about 3% to about 30% by weight of prepolymer, with from about 3 to about 15% by weight being more typical.

The polycyanates may be dicyanate compounds, although tricyanates and higher polycyanates can be used. When the oleochemical polyols are reacted with polycyanates, the polyurethane prepolymer is terminated at each end with cyanate functional groups (—O—C≡N).

When polyisothiocyanates are used in forming the polyurethane prepolymer, the polyisothiocyanates are typically diisothiocyanate compounds, although triisothiocyanates and higher polyisothiocyanates can be used as well. When the oleochemical polyols are reacted with polyisothiocyanates, the polyurethane prepolymer is terminated at each end with isothiocyanate functional groups (—N═C═S).

The formation of the polyurethane prepolymer is typically carried out in a suitable solvent. The solvent may be any solvent in which the reactants are readily dispersed or dissolved and are generally non-reactant with the polyurethane prepolymer. Such solvents are generally free of hydroxyl, amine, or other functional groups wherein hydrogen is joined to a highly electronegative element such as oxygen, nitrogen, sulfur, etc., so that the hydrogen may readily react with the formed polyurethane prepolymer to cause premature gelation. The solvents that do not have active hydrogen may include esters, such as ethyl acetate, butyl acetate, amyl acetate, dipropyl acetate, cellosolve acetate, carbitol acetate or dimethylesters of dibasic acids; ketones such as methyl ethyl ketone, methyl isobutyl ketone or cyclohexanone; ethers, such as dipropyl ether, dioxane and tetrahydrofuran; and hydrocarbons such as toluene, benzene, xylene, mineral oil, mineral spirits, diesel, bio-diesel (methyl ester, ethyl ester) or oil; chlorinated hydrocarbon solvents such as methylene chloride, trichloroethylene, perchloroethylene, chlorobenzene, dichlorobenzene; and nitoraliphatic solvents. All the solvents may be used individually or as a mixture.

In another embodiment, a blocking agent may be used to block some or all of the free isocyanate or free reactive groups of the polyurethane prepolymer. Because the free isocyanate groups will react readily with active hydrogen compounds at room temperature, the blocking agent will render the free isocyanate groups inactive. This may also apply to the free reactive groups formed when polycyanates or polyisothiocyanates are used instead of polyisocyanates. The use of blocking agents provides more stable treatment fluids, inhibits the premature reaction with water and allows longer working times to be used to facilitate placement of the treatment fluid. The blocking agents may also result in lower viscosity treating fluid.

In still another embodiment, the oleochemical polyol is used in an unreacted or substantially unreacted form in combination with polyisocyanate, polycyanates or polyisothiocyanates in which the free reactive groups have been blocked from reaction. The reactants and solvents used for the polyurethane prepolymer described previously may also be used for this application. This “premix” system wherein the reactants are mixed but no or substantially no polyurethane or polyurethane prepolymer is formed in the solution provides a substantially lower viscosity treatment fluid because the reactants have lower molecular weights than do the polyurethane prepolymers. The premix components may have a substantially lower average molecular weight than the prepolymers, with average molecular weights of the premix components being on the order of 10,000 or less (e.g. from about 3000 to about 5000), as measured by gel permeability chromatography (GPC). In contrast, the prepolymer may have an average molecular weight on the order of 1,000,000 or more (e.g. 2,000,000 to about 4,000,000), as measured by GPC. The premix may also be used in combination with different amounts of the polyurethane prepolymer to form the treatment fluid.

The blocking agent used with the polyurethane prepolymer or premix system as described above is selected to block the reactive free isocyanates or reactive groups, which can then be “de-blocked” or reactivated at certain temperatures or conditions. This may be done by reacting the isocyanate or free reactive groups with an active hydrogen compound. Upon heating in the presence of a nucleophile, the isocyanate groups are de-blocked or re-activated. Once the free isocyanates or reactive groups are de-blocked by heating to a selected temperature, the blocked isocyanate groups are re-activated to trigger formation of the hard polymeric materials that will facilitate blocking of the water pathways.

The blocking agents may include those compounds capable of blocking the isocyanate groups. These may include ketoximes, such as dimethyel ketoxime and methyl ethyl ketoxime. Dimethyel ketoxime has been shown to have a de-block temperature of approximately 140° C., while methyl ethyl ketoxime has been shown to have a de-block temperature of 120° C. Other suitable blocking materials and systems are described in U.S. Pat. Nos. 3,583,943; 3,621,000, 3,394,389, 4,677,179 and 6,051,675, each of which is incorporated herein by reference in its entirety. ε-caprolactam (ε-CAP), 1,2,4-triazole (TRIA), diisopropylamine (DIPA), 3,5-timethylpyrazole (DMP), diethyl malonate (DEM) may also be used as suitable blocking agents. The blocking agents may be used in amounts sufficient to block all or a portion of the free isocyanate or free reactive groups.

The blocking agents may be used in conjunction with de-blocking and curing catalysts. These catalysts may include tin-containing catalysts such as tin-(II) salts of carboxylic acids, such as tin acetate, tin octoate, tin ethyl hexanoate and tin laurate, and tin-(IV) compounds, such as dibutyl tin dilaurate, dibutyl tin dichlorite, dibutyl tin diacetate, dibutyl tin dilaurate, dibutyl tin meleate or dibutyl tin diacetate. Other catalysts that may be used include metal acetonyl acetates, quaternary ammonium salts, zinc N-ethyl-N-phenyl dithiocarbamate, pentamethyldiethylenetriamine benzoate, cyclohexylamine acetate, N,N-dimethylcyclohexylamine acetate, ketimines, N-methyl morpholine, stannic chloride, butyl tin trichloride, bis(2-ethylhexyl)tin oxide, 1,3-diacetoxy tetrabutyl stannoxate, dibutyl dibutoxy tin, lead napthenate, bismuth trichloride, bismuth octonoate, tetra kis(2-ethylhexyl)titanate and tetrabutoxy titanium. The catalyst mentioned can be use separately or as a mixture with different ratios. Other catalysts, such as those described in the above-referenced patents of the preceding paragraph may also be used.

The polyurethane prepolymer and premix systems containing blocking agents for blocking the free isocyanate or reactive groups is used in the same manner as the polyurethane prepolymer without such blocking agents. The premix system wherein the oleochemical polyol is not prereacted with the polyisocyanate to form the polyurethane prepolymer may be advantageously used in certain applications where lower viscosity is required. The premix or polyurethane prepolymer with the blocking agent is dispersed in a suitable treatment carrier fluid and introduced into the formation. The selection of the blocking agents may take into account the temperature of the formation being treated so that de-blocking or reactivation of the blocked free reactive groups takes place to allow the polyurethane prepolymer and premix system to react.

The same or a different solvent as used in forming the polyurethane prepolymer may be used as the carrier fluid for introducing the polyurethane prepolymer or premix systems into the water-bearing zone being treated. The solvent used for the carrier fluid will also typically be non-reactive with the polyurethane prepolymer or premix. The carrier solvent may include those solvents without active hydrogen. These may include esters, such as ethyl acetate, butyl acetate, amyl acetate, dipropyl acetate, cellosolve acetate, carbitol acetate or dimethylesters of dibasic acids; ketones such as methyl ethyl ketone, methyl isobutyl ketone or cyclohexanone; ethers, such as dipropyl ether, dioxane and tetrahydrofuran; and hydrocarbons such as toluene, benzene, xylene, mineral oil, mineral spirits, diesel, bio-diesel (methyl ester, ethyl ester) or oil; chlorinated hydrocarbon solvents such as methylene chloride, trichloroethylene, perchloroethylene, chlorobenzene, dichlorobenzene; and nitoraliphatic solvents. All the solvents may be used individually or as a mixture.

The solvent with dispersed polyurethane prepolymer or premix may be used to provide a treatment fluid having a viscosity of from about 1 mPa-s to about 40 mPa-s at a shear rate of about 170 s⁻¹ at surface conditions so that it may be readily pumped downhole into the formation. The carrier fluid is typically used in an amount of from about 97% to about 95%, 90%, 80%, 70%, or 60% by weight of the treatment fluid. In certain situations, the components of the treatment fluid may be diluted to provide a lower solid content so that they are less viscous.

Additives that may accelerate or delay the reaction rate of the polyurethane prepolymer or the premix with water may be incorporated into the treatment fluid. These may include catalysts that facilitate curing of the polyurethane. These catalysts may include tin-containing catalysts such as tin-(II) salts of carboxylic acids, such as tin acetate, tin octoate, tin ethyl hexanoate and tin laurate, and tin-(IV) compounds, such as dibutyl tin dilaurate, dibutyl tin dichlorite, dibutyl tin diacetate, dibutyl tin dilaurate, dibutyl tin meleate or dibutyl tin diacetate. Other catalysts may include those containing tertiary amines. Examples of other catalysts include metal acetonyl acetates, quaternary ammonium salts, zinc N-ethyl-N-phenyl dithiocarbamate, pentamethyldiethylenetriamine benzoate, cyclohexylamine acetate, N,N-dimethylcyclohexylamine acetate, ketimines, N-methyl morpholine, stannic chloride, butyl tin trichloride, bis(2-ethylhexyl)tin oxide, 1,3-diacetoxy tetrabutyl stannoxate, dibutyl dibutoxy tin, lead napthenate, bismuth trichloride, bismuth octonoate, tetra kis(2-ethylhexyl)titanate and tetrabutoxy titanium. The catalyst mentioned can be use separately or as a mixture with different ratios.

Other additives of the treatment fluid may include fibrous materials. These fibrous materials may be used in the form of mats, tows, full-length fibers, non-woven structures, woven structures or random staple-fiber mixtures, glass fibers. Calcium carbonate, fine cement, colloidal silica, carbon black, silica gel, gypsum, active carbon, silicones, fungistatic and/or bacteriostatic agents can also be added.

In treating a formation, the treatment fluid containing the polyurethane prepolymer or premix may be introduced directly into the wellbore without any pretreatment or preflush. The treatment fluid may be injectable through the matrix or near the wellbore. When the treatment fluid enters the hydrocarbon-bearing zones the polyurethane prepolymer or premix will remain stable and the free reactive groups (blocked or unblocked) will merely form two homogeneous layers with the hydrocarbons that are easily flowable relative to one another. In the systems with blocked reactive groups, the reactive groups will remain blocked until the treatment fluid reaches the selected temperature to facilitate de-blocking of the reactive groups. As discussed earlier, the blocking agent may be selected so that de-blocking occurs at the temperature of the portion of the subterranean formation being treated. The type and/or amount of the blocking agent used may be changed or adjusted depending upon the formation temperatures for which the treatment fluid is to be used. Simple tests at the surface at the formation temperatures and conditions may be conducted with the various blocking agents to facilitate such selection.

When the treatment fluid comes into contact with water or other aqueous fluids, such as fresh water, brine, salt water, etc., the polyurethane prepolymer or premix will react and begin to gel. This will create a hard polymeric layer that will facilitate blocking of the water pathway. Providing a gelation time of about 24 hours or less when contacted with water or other aqueous fluid ensures that the treatment fluid sets near the wellbore so that it does not penetrate the formation significantly. This ensures that portions of the formation remote from the wellbore are not damaged. In certain embodiments, the polyurethane prepolymer may have gelation times of from about ½ hour to about 15 hours, more particularly from about 1 hour to about 10 hours, or more particularly from about 3 hours to about 10 hours.

After a shut in period, the well may be brought back into production, wherein fluids are produced from the well. Other treatments may also be carried out after treatment with the treatment fluid and prior to production.

In certain applications, the formation may be pretreated prior to introducing the polyurethane prepolymer or premix with a pretreatment fluid or preflush. This may be an oil or non-aqueous fluid that will not react with the polyurethane prepolymer premix so that residual water or aqueous fluids that have migrated from the water-bearing zones are removed. This allows the polyurethane prepolymer to react closer to the water-bearing zones so that other areas of the formation or well are not damaged. Examples of suitable preflush fluids include diesel, xylene or other aromatic hydrocarbons.

In another embodiment, palm oil, palm oil derivatives or other fatty acids are used to selectively shut off or block water-bearing zones. Palmitic acid and palmitic acid derivatives, which may be obtained by the hydrolysis of palm oil, and other fatty acids, is miscible with potassium, sodium, ammonium, and other similar monovalent ions and provides a solution. This solution may be pumped into a water zone containing calcium, barium or other multivalent ions to form an insoluble precipitate.

When contacting a hydrocarbon or oil-bearing zone, however, the hydrocarbon will not cause any precipitation of the palmitic acid/monovalent salt solution so that the permeability of the hydrocarbon-bearing zone is not altered. The precipitate formed when contacting the multivalent brine with palmitic acid solution will lower the permeability of water-bearing zone, however.

The palmitic acid derivatives can be its salts, which may be used with potassium, sodium, ammonium or similar monovalent salts. Additionally, the palmitic acid derivative may be an anhydride, acyl halide, amide or alcohol.

Palm oil can also be used in combination with a hydrolyzing or oxidizing agent as palmitic acid precursor. By combining palm oil with a hydrolyzing agent, palmitic acid may be formed in situ after it is introduced into the formation.

Both the hydrolyzing agent and oxidizing agent may be encapsulated or emulsified to further delay reaction with the palm oil or other oils. A slow acting oxidizing agent may also be used.

Carrier fluids or solvents for forming the palmitic acid/monovalent salt treatment solution may by aqueous or non-aqueous. Examples of carrier fluids include those aqueous fluids that do not contain multivalent ions. Hydrocarbons, such as crude oil, diesel, etc. may also be used as the carrier fluid or solvent.

In treating a formation, the treatment fluid containing the palmitic acid or palmitic acid precursors with any hydrolyzing or oxidizing agent and monovalent salt may be introduced directly into the wellbore without any pretreatment. Alternatively, asolution of multivalent ions, such as calcium or barium, may be used as a preflush to pretreat water-bearing zones, particularly those that contain no or little multivalent salts, so that the insoluble precipitate is formed upon contact with the treatment fluid. An acid or other stimulation may also be used in the water-bearing zones to dissolve portions of the formation and form CaCl₂ in situ. This can then react with the treatment fluid to form the precipitate.

The following examples serve to further illustrate the invention.

### EXAMPLES

### Example 1

Polyurethane prepolymers were prepared using a palm-based polyol having a hydroxyl value of 155 to 175 mg KOH/g formed from refined, bleached and deodorized palm olein, was predried in an oven at 176° F. (80° C.). The solvent used was a mixed xylene solvent, available from Sigma-Aldrich. The xylene solvent was dried using a molecular sieve before synthesis of the prepolymer. The polyisocyanate used was diphenylmethane-4,4′-diisocyanate (MDI), available from Merck.

To prepare each batch of the polyurethane prepolymer, the diphenylmethane-4,4′-diisocyanate was first poured into a two-neck round bottom flask. The MDI was purged within the flask with nitrogen gas for five minutes to expel moisture from air trapped in the flask. The flask was then submerged in a water bath placed on a heating mantle and heated to temperatures of not more than 140° F. (60° C.). The flask contents were constantly and moderately stirred with a magnetic bar. Different calculated amounts of polyol and solvent were then added to the flask drop-wise under continuous stirring. The amount of solvent used was from about 70% to about 96% by weight. The amount of palm-based polyol used was calculated to provide a free NCO concentration of the formed polyurethane prepolymer of approximately 4.12%, 7.17%, 9.61% and 15.10% by weight of prepolymer. The amount of prepolymer to provide the desired free NCO content was calculated by using the following equation:

$$NCO \% = 42 \times \frac{( \begin{matrix}Number of equivalent of isocyanate - \\ Number of equivalent of polyol\end{matrix} )}{Total weight of Isocyanate and Polyol} \times 100 \% \qquad ( 5 )$$

The mixture was stirred for another 30 minutes after all of the polyol had been added to the MDI.

Table 1 below presents the results of the prepolymer synthesis and physical properties of the palm-based polyurethane prepolymer.

TABLE 1

| | Sample 1 | Sample 2 | Sample 3 | Sample 4 | Sample 5 |
|---|---|---|---|---|---|
| Polyol, g | 50.0 | 30.0 | 15.0 | 20.0 | 25.0 |
| MDI, g | 30.0 | 50.0 | 25.0 | 20.0 | 20.0 |
| Xylene, g | 43.5 | 69.6 | 69.6 | 130.5 | 147.9 |
| Free NCO % | 4.12 | 15.10 | 15.10 | 9.61 | 7.17 |
| Solid | 64.80 | 53.48 | 36.50 | 23.46 | 23.33 |
| Content % | | | | | |
| Physical | Solid | Solid | Liquid | Liquid | Liquid |
| Appearance | | | | | |
| Solvent | Xylene | Xylene | Xylene | Xylene | Xylene |
| Viscosity | — | — | 9 | 11 | 10 |
| (mPa-s)* | | | | | |
| Specific | — | — | 0.91 | 0.94 | 0.92 |
| Gravity | | | | | |

*At 170 sec⁻¹ and 80° F. (26.7° C.).

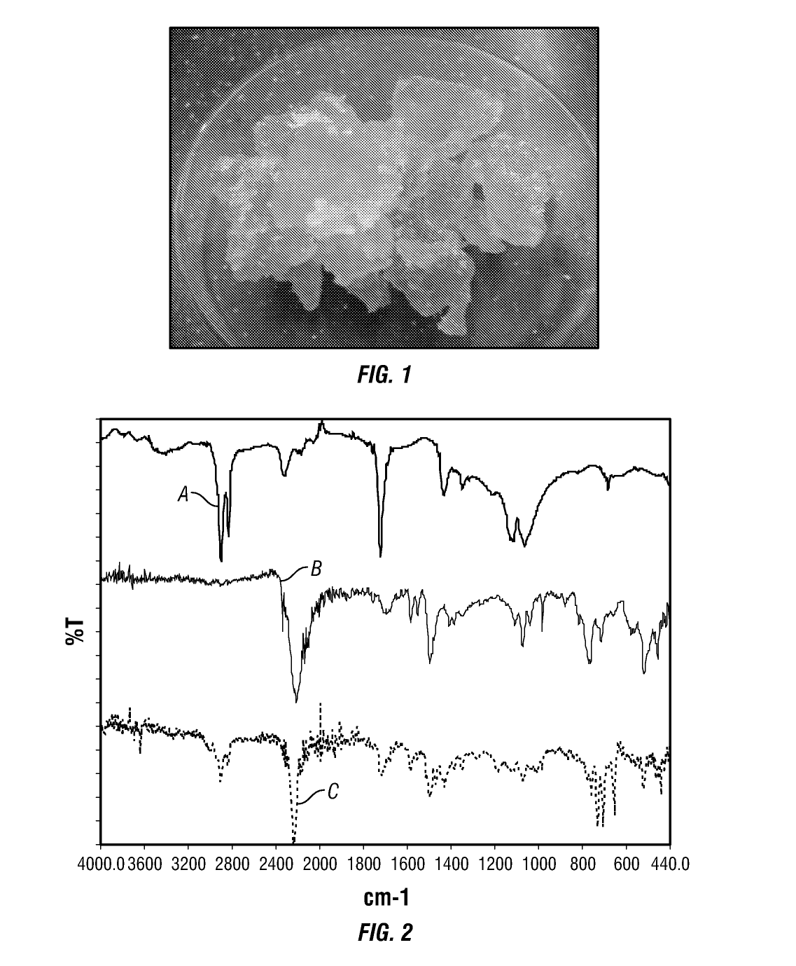

Xylene was used as a solvent to dilute the concentration of the prepolymer in order to provide a low viscosity before reaction with brine. Viscosities were measured using a Fann35 viscometer. The solid content refers to the polymer portion, which included palm-oil-based polyol and MDI. A 50% solid content indicates the solution contains 50% xylene solvent and 50% as prepolymer. Sample 1 and 2 formed a solid gel during synthesis. Samples 3 and 4 show that lower solid content can prevent pre-gelation of the prepolymer during synthesis. FIG. 1 shows the physical appearance of the pre-gelation solid, such as formed in Samples 1 and 2. When pre-gelation of the prepolymer occurs, it may be readily dissolved with additional solvent. Generally, the palm-based prepolymer solution shows low viscosity and low specific gravity.

### Example 2

A portion of the prepolymer solution from Sample 3 was tested using Fourier Transform Infrared Spectroscopy (FTIR) analysis using a Perkin-Elmer GX FTIR spectrometer. The results are presented in FIG. 2. The prepolymer sample (Spectrum C) was compared with the palm-based polyol (Spectrum A) and MDI (Spectrum B). A drop of each liquid sample was placed on the center of the sample holder plate and then placed in position by using a cell holder. The samples were scanned through the wave number range 4000 cm⁻¹ to 400 cm⁻¹. The background was scanned without any liquid solution. Table 2 shows the characteristic vibrations of the isocyanate groups at different infrared frequency ranges for each of the samples. Tables 3 and 4 show the major absorption peaks for the MDI and palm-based prepolymer, respectively.

TABLE 2

| Vibration | Wavenumber cm⁻¹ | Intensity |
|---|---|---|
| υₐₛ(NCO) | 2300-2250 | Very Strong |
| υₛ(NCO) | 1450-1400 | Very Weak |
| Δ⊥(NCO) | 650-600 | Poorly defined |
| Δ^{\|\|}(NCO) | 600-590 | Strong |

TABLE 3
Major Absorption Peaks of Diphenylmethane-4:4′-Diisocyanate (MDI)

| Bonding | Wave number (cm⁻¹) |
|---|---|
| NH | 3394 |
| CH₃ stretching | 2917 |
| NCO stretching | 2269, 1434 |
| Aromatic C═C stretching | 1614, 1574, 1525 |
| CH₃ (bending) | 1434, 1381 |

TABLE 4
Major Absorption Peaks of Palm-Based Prepolymer

| Bonding | Wave number (cm⁻¹) |
|---|---|
| C—H, stretching | 2971 |
| NCO stretching | 2274 |
| Carbonyl C═O | 1727 |
| C—CH₃ deformation | 1373 |
| C—O stretch | 1226 |
| C—O—C stretch | 1107 |

As can be seen in FIG. 2, the absorption peak of the isocyanate groups were clearly indicated by the broad peak at 2269 to 2274 cm⁻¹. On the other hand, Spectrum C of FIG. 2 shows the typical FTIR spectrum for diisocyanate-terminated prepolymer after the prepolymerization reaction. From FIG. 2 the OH groups of the palm-based polyol are seen by the peak at 3484 cm⁻¹. The prepolymer (Spectrum C) shows a marked decrease in this peak, indicating that the OH groups that initially existed in the polyol have disappeared. The terminal NCO groups are indicated by the broad peak at 2274.2 cm⁻¹. This provides a good indication that the palm-based polyol has been incorporated into the prepolymer.

### Example 3

Palm-based prepolymer solutions from Example 1 containing free NCO in varied amounts of 7.1 wt. % (Sample 5), 9.6 wt. % (Sample 4) and 15.1 wt. % (Sample 3) were mixed with an aqueous 4 wt. % KCl solution at a prepolymer solution/brine volume ratio of 1:3 in a small sample bottle. The mixture was mixed homogenously and kept in a water bath at about 158° F. (70° C.). At 30-minute intervals, the samples were checked and assigned a gel code as described below by a 90 degree inversion of the sample bottle. The results are presented in Table 5 below.

Gel Code
X—No Detectable Gel Formed: Gel appears to have the same viscosity (fluidity) as the original prepolymer solution and no gel is visually detected.
XX—Barely Flowing Gel: The gel can barely flow and/or a significant portion (>40%) of the gel does not flow upon 90 degree inversion.
XXX—Rigid Gel: There is no gel-surface and the gel is not flowable upon 90 degree inversion.

TABLE 5

| Time | NCO % 7.1 | NCO % 9.6 | NCO % 15.1 |
|---|---|---|---|
| 0 min | x | x | x |
| 60 min | x | x | x |
| 100 min | x | x | xx |
| 140 min | x | x | xxx |
| 170 min | xx | xx | xxx |
| 180 min | xxx | xxx | xxx |

Table 5 shows that higher NCO % leads to high reactivity between the prepolymer solution and KCl. The higher isocyanate concentration will thus result in higher reactivity.

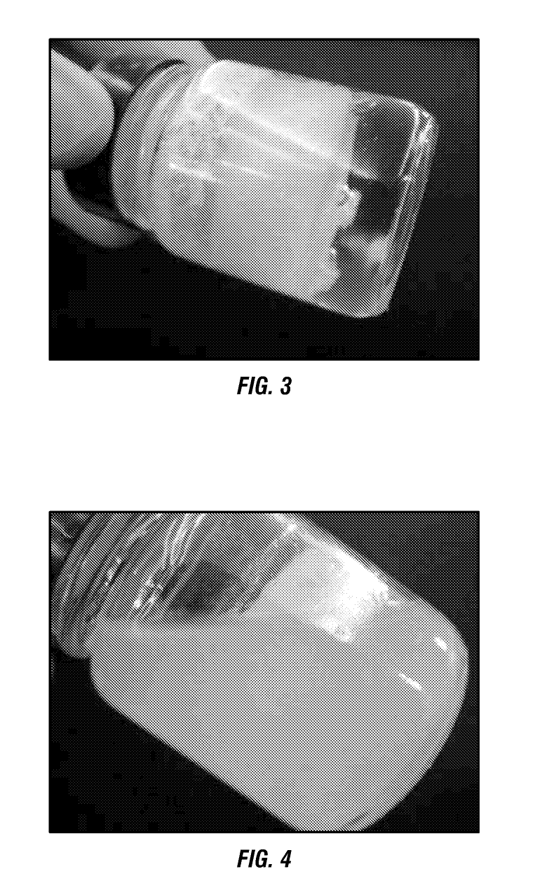

FIG. 3 shows an example of the physical appearance of the cured palm-based polyurethane-polyurea (Sample 3) after contact with a 4 wt. % KCl solution at 158° F. (70° C.). The cured polyurethane is a rigid but elastic gel layer. In contrast, FIG. 4 shows the palm-based polyurethane (Sample 3) in solution with mineral spirits at 158° F. (70° C.). As shown in FIG. 4, the solution is readily flowable when the sample bottle is inverted.

### Example 4

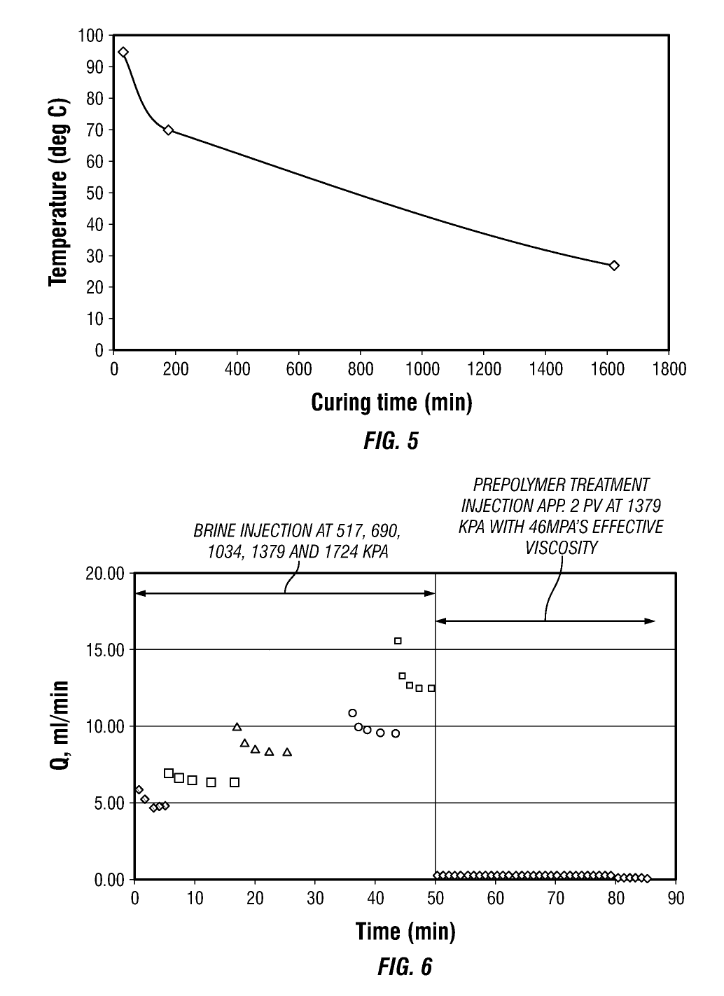

A palm-based prepolymer solution containing free NCO in an amount of 7.1% was mixed with an aqueous 4% wt % KCl solution at a prepolymer solution/brine volume ratio of 1:3 in a small sample bottle. The mixture was mixed homogenously and kept in a water bath at about 80.6° F. (27° C.). The same mixture was also prepared and kept in a water bath at 158° F. (70° C.) and 203° F. (95° C.). The samples were checked and the time required for the prepolymer to turn into a rigid gel was determined. The results are presented in FIG. 5. As can be seen in FIG. 5, the prepolymer turned into a rigid gel within 0.5 hours at 203° F. (95° C.). In contrast, it took 26 hours at 80.6°(27° C.) before the prepolymer turned to a rigid gel.

### Example 5

Different treatment fluids containing polyurethane prepolymer and polyurethane premix were prepared. The polyol was a palm oil derived polyol having a hydroxyl value of 155 to 175 mg KOH/g derived from refined, bleached and deodorized palm olein. The polyisocyanate used was diphenylmethane-4,4′-diisocyanate (MDI). The blocking agent used was 3,5-dimethylpyrazole. Xylene or diesel was used as the base fluid. Treatment fluids TF1 and TF4 were prepared in a similar manner to the samples of Example 1 to form the polyurethane prepolymer, but did not include any blocking agent. In fluids TF2 and TF3 the MDI was combined with the blocking agent prior to combining with the polyol to form a “premix” without formation of the polyurethane prepolymer. The formulations for each of the treatment fluids TF1-TF4 are presented in Table 6 below.

TABLE 6

| | | Quantity | | | |
|---|---|---|---|---|---|
| Additives | Description | TF1 | TF2 | TF3 | TF4 |
| Xylene | Base fluid | 80 ml | 80 ml | — | 96.67 ml |
| Diesel | Base fluid | — | — | 80 ml | — |
| Polyol | Hydroxyl compound | 15 g | 15 g | 15 g | 1.25 g |
| MDI | diphenylmethane-4:4′- | 25 g | — | — | 2.08 g |
| | diisocyanate | | | | |
| Blocked | Blocked isocyanate | — | 25 g | 26 g | — |
| iscyanate | | | | | |

### Example 7

Injectivity tests were conducted on cylindrical sandstone core samples for each of the treatment fluids TF1-TF4 from Example 6 to determine the injectivity of the treatment fluids and the damage of the treatment fluid toward the core plug. The core samples used had the following properties listed in Table 7 below.

TABLE 7

| | | | | Pore | | |
|---|---|---|---|---|---|---|
| Core | Test | Length, | Diameter, | volume, | % | Permeability, |
| number | Fluid | mm | mm | cc | Porosity | μm² |
| T1 | TF1 | 26.2 | 25.6 | 2.59 | 19.25 | 72.31 |
| T2 | TF2 | 29.3 | 25.5 | 3.12 | 20.61 | 93.40 |
| T3 | TF3 | 25.8 | 25.3 | 2.87 | 22.22 | 110.16 |
| T4 | TF4 | 24.7 | 25.3 | 2.86 | 22.95 | 166.42 |

A 2% wt/wt KCl brine was used as the medium to determine the performance of the treatment fluid during injection and during brine backflow. The following test procedures were used at ambient temperatures:
1. Measured the porosity and permeability of the core by using Poroperm.
2. Vacuum saturate core plug in 2% wt/wt KCl brine for 2 hours.
3. Assemble core in high temperature/high pressure (HTHP) fluid loss cell and place 110 ml of 2% wt/wt KCl brine solution on top of core plug injection surface.
4. Apply series of increasing pressures 25 psi (172.4 kPa), 50 psi (344.8 kPa), 75 psi (517.2 kPa), 100 psi (689.6 kPa), 125 psi (862.0 kPa), 150 psi (1034.4 kPa), 175 psi (1206.8 kPa) and 200 psi (1379.2 kPa).
5. Measure the volume/weight of filtrate produced as a function of time and for each differential pressure applied.
6. Determine the flow rate of filtrate produced when steady state conditions are reached at each differential pressure applied.
7. Bleed off HTHP pressure and remove core plug.
8. Remove all the residual 2% wt/wt KCl brine solution.
9. Place the treatment fluid on top of core plug injection surface.
10. Apply a suitable differential pressure so that the treatment fluid invades and floods the core. Measures the volume/weight of treatment fluid produced as a function of time and determine the flow rate when steady state conditions are reached. Ensure the core is fully saturated with the treatment fluid (typically, a treatment volume which is equivalent to 10-20 pore volumes is injected).

The resistance factor (Q_{b}/Qₐ) of the reacted treatment fluid at ambient temperature conditions was determined using the following test procedures:
1. Bleed off HTHP pressure and remove core plug, cure the core plug (immersed in treatment fluid) in a high temperature oven.
2. After curing, assemble the cured core in the HTHP fluid loss cell and place 110 ml of synthetic brine solution on top of core plug production surface. Note that for this backflow experiment, the core is inverted so that that the brine flows in the “reservoir-to-wellbore” direction.
3. Apply a series of increasing pressures 25 psi (172.4 kPa), 50 psi (344.8 kPa), 75 psi (517.2 kPa), 100 psi (689.6 kPa), 125 psi (862.0 kPa), 150 psi (1034.4 kPa), 175 psi (1206.8 kPa) and 200 psi (1379.2 kPa) (corresponding to an increasing series of pressure gradients 600 to 2400 psi/ft (13.775 mPa/m to 55.102 mPa/m)).
4. Measure the volume/weight of filtrate produced as a function of time for each differential pressure applied.
5. For each equivalent applied differential pressure, determine the resistance factor=Q_{b}/Qₐ, where Q_{b} is the steady-state brine flow rate of the core before treatment and Qₐ is the steady-state brine flow rate of the core after treatment and curing.
6. Collect all the effluent during backflow in order to assess the retention of treatment fluid.

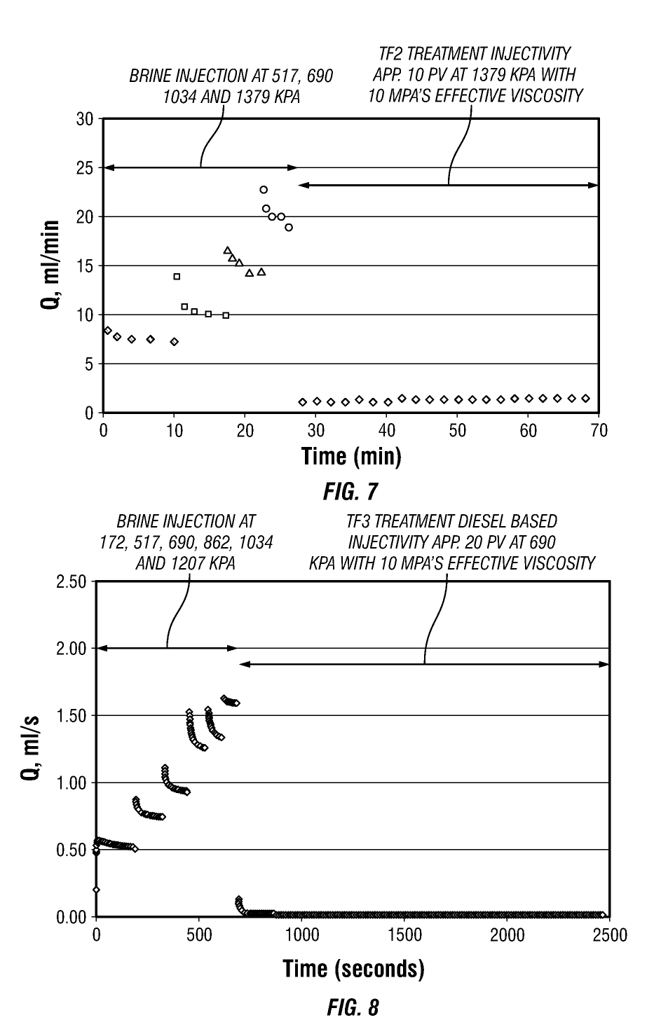

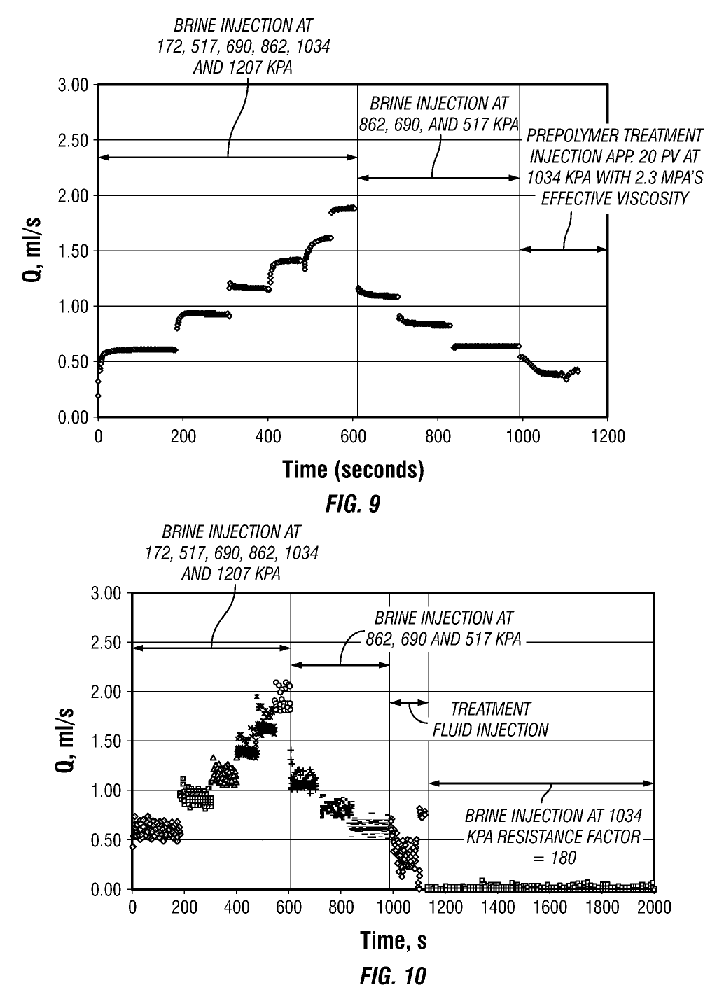

Table 8 below summarizes the injectivity test results for the different treatment fluids. In all four tests, no filter cake was observed at the core surfaces after injection. Fluid TF1 showed very low injectivity after only 2 pore volumes of injection. This may be due to the higher molecular weight of the prepolymer and its reactivity during injection. Fluid TF4 that comprised the same molecular structure but with lower solid content, i.e., 3.85 wt. %, showed excellent injectivity. The “premix” treatment fluids TF2 and TF3 employing blocking agents exhibited excellent injectivity properties. This may be attributed to the lower molecular weight polyol component and the efficient blocking of the fluid reactivity. FIGS. 6-9 show the injection flow rates of brine over time for each of treated core samples with fluids TF1-TF4, respectively.

TABLE 8

| | SAMPLE | | | |
|---|---|---|---|---|
| | TF1 | TF2 | TF3 | TF4 |
| Type of | No Blocking Agent | Blocking Agent | Blocking Agent | No Blocking |
| treatment | | | | Agent |
| fluid | | | | |
| Solid content | 36.8 wt % | 36.8 wt % | 36.8 wt % | 3.85 wt % |
| Base fluid | Xylene | Xylene | Diesel | Xylene |
| Effective | 46 mPa · s for two pore | 10 mPa · s | 10 mPa · s | 2.3 mPa · s |
| viscosity* | volumes injected but | steady-state | steady-state | steady state |
| | therafter injectivity | | | |
| | declined | | | |
| Volume | 2 pore volume at | 10 pore volume | 20 pore volume | 20 pore volume |
| treatment | applied pressure | at applied | at applied | at applied |
| fluid injected | 200 psi (1379 kPa) | pressure 200 psi | pressure 100 psi | pressure 150 psi |
| | | (1379 kPa) | (690 kPa) | (1034 kPa) |
| Filter cake | No | No | No | No |
| formation | | | | |

*Effective viscosity during injection estimated by ratio Q_{TF}/Q_{brine} where Q_{TF} is the steady-state flowrate during treatment fluid injection and Qbrine is the steady-state flowrate during brine flow at the same differential pressure gradient. The viscosity of 2 wt % KCl at T = 25 C. is around 1 mPa · s.

### Example 8

After injection of 20 pore volumes of the premix treatment fluid TF4 which employed a blocking agent in core sample T4, from Examples 6 and 7, the core was cured at 80° C. in an oven. A resistance factor of 180 was determined as described above under ambient temperature conditions. FIG. 10 shows the resistance factor determination. The results suggest that a relatively low solid content (3.85 wt. %) is effective in shutting off the flow of water from a watered out zone with an initial permeability of 166.42 μm². A higher solids content may be required to facilitate water shut off for higher permeabilities (e.g. 1 μm²).

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

We claim:

1. A method of treating a subterranean formation penetrated by a wellbore, the method comprising:
forming a treatment fluid of a solvent containing at least one of 1) a premix of an oleochemical polyol, at least one of polyisocyanate, polycyanate and polyisothiocyanate, and a blocking agent to temporarily block all or a portion of free reactive groups of said at least one of polyisocyanate, polycyanate and polyisothiocyanate, and 2) a polyurethane prepolymer formed by reacting an oleochemical polyol and at least one of polyisocyanate, polycyanate and polyisothiocyanate; and
introducing the treatment fluid into the wellbore.

2. The method of claim 1, wherein:
the treatment fluid contains a solvent and a premix of an oleochemical polyol, at least one of polyisocyanate, polycyanate and polyisothiocyanate, and a blocking agent.

3. The method of claim 1, wherein:
the oleochemical polyol is derived from at least one of palm oil, olive oil, castor oil, soybean oil, almond oil, safflower seed oil, niger seed oil, tobacco seed oil, peanut oil, cottonseed oil, sunflower seed oil, rapeseed oil, linseed oil, tung oil, babassu kernel oil, sesame oil, coconut oil, and corn oil.

4. The method of claim 1, wherein:
wherein there is an excess of the at least one of polyisocyanate, polycyanate and polyisothiocyanate is used with the oleochemical to provide the polyurethane prepolymer to provide free reactive groups.

5. The method of claim 4, wherein:
a blocking agent is provided with the polyurethane prepolymer to block all or a portion of the free reactive groups from reacting below a selected temperature.

6. The method of claim 1, wherein:
the polyurethane prepolymer has free reactive groups that make up from about 3% to less than about 40% by weight of the polyurethane prepolymer.

7. The method of claim 1, wherein:
the treatment fluid further includes a catalyst of at least one of a tin-(II) salts of carboxylic acids, tin acetate, tin octoate, tin ethyl hexanoate, tin laurate, a tin-(IV) compound, dibutyl tin dilaurate, dibutyl tin dichlorite, dibutyl tin diacetate, dibutyl tin dilaurate, dibutyl tin meleate, dibutyl tin diacetate, metal acetonyl acetates, quaternary ammonium salts, zinc N-ethyl-N-phenyl dithiocarbamate, pentamethyldiethylenetriamine benzoate, cyclohexylamine acetate, N,N-dimethylcyclohexylamine acetate, a ketimine, N-methyl morpholine, stannic chloride, butyl tin trichloride, bis(2-ethylhexyl)tin oxide, 1,3-diacetoxy tetrabutyl stannoxate, dibutyl dibutoxy tin, lead napthenate, bismuth trichloride, bismuth octonoate, tetra kis(2-ethylhexyl)titanate, tetrabutoxy titanium and mixtures of any of these.

8. The method of claim 1, wherein:
the solvent is selected from at least one of ethyl acetate, butyl acetate, amyl acetate, dipropyl acetate, cellosolve acetate, carbitol acetate, dimethylesters of dibasic acids, methyl ethyl ketone, methyl isobutyl ketone, cyclohexanone, dipropyl ether, dioxane, tetrahydrofuran, toluene, benzene, xylene, mineral oil, mineral spirits, diesel, bio-diesel, crude oil, methylene chloride, trichloroethylene, perchloroethylene, chlorobenzene, dichlorobenzene, nitoraliphatic solvents and combinations of these.

9. The method of claim 1, further comprising:
producing fluids from the wellbore after introduction of the treatment fluid.

10. The method of claim 1, wherein:
the treatment fluid has a viscosity of from about 1 mPa-s to about 40 mPa-s at a shear rate of about 170 s⁻¹ at surface conditions.

11. A composition for treatment of a subterranean formation for water control, the composition comprising;
a solvent and at least one of 1) a premix of an oleochemical polyol, at least one of polyisocyanate, polycyanate and polyisothiocyanate, and a blocking agent to temporarily block all or a portion of free reactive groups of said at least one of polyisocyanate, polycyanate and polyisothiocyanate, and 2) a polyurethane prepolymer dispersed within the solvent, the polyurethane prepolymer being formed by reacting an oleochemical polyol and at least one of polyisocyanate, polycyanate and polyisothiocyanate.

12. The composition of claim 11, wherein:
the composition has an excess of the at least one of polyisocyanate, polycyanate and polyisothiocyanate used with the oleochemical to provide free reactive groups.

13. The composition of claim 12, wherein:
the polyurethane prepolymer dispersed within the solvent further comprises a blocking agent to block all or a portion of the free reactive groups from reacting below a selected temperature.

14. The composition of claim 11, wherein:
the composition comprises a solvent and a premix of an oleochemical polyol, at least one of polyisocyanate, polycyanate and polyisothiocyanate, and a blocking agent to temporarily block all or a portion of free reactive groups of said at least one of polyisocyanate, polycyanate and polyisothiocyanate.

15. The composition of claim 11, wherein:
the oleochemical polyol is derived from at least one of palm oil, olive oil, castor oil, soybean oil, almond oil, safflower seed oil, niger seed oil, tobacco seed oil, peanut oil, cottonseed oil, sunflower seed oil, rapeseed oil, linseed oil, tung oil, babassu kernel oil, sesame oil, coconut oil, and corn oil.

16. The composition of claim 11, wherein:
the treatment fluid has a viscosity of from about 1 mPa-s to about 40 mPa-s at a shear rate of about 170 s⁻¹ at surface conditions.

17. The composition of claim 11, wherein:
the oleochemical polyol has two or more —OH groups located on adjacent carbon atoms.

18. The composition of claim 11, wherein:
the polyurethane prepolymer has free reactive groups that make up from about 3% to less than about 40% by weight of the polyurethane prepolymer.

19. The composition of claim 11, further comprising:
a catalyst of at least one of a tin-(II) salts of carboxylic acids, tin acetate, tin octoate, tin ethyl hexanoate, tin laurate, a tin-(IV) compound, dibutyl tin dilaurate, dibutyl tin dichlorite, dibutyl tin diacetate, dibutyl tin dilaurate, dibutyl tin meleate, dibutyl tin diacetate, metal acetonyl acetates, quaternary ammonium salts, zinc N-ethyl-N-phenyl dithiocarbamate, pentamethyldiethylenetriamine benzoate, cyclohexylamine acetate, N,N-dimethylcyclohexylamine acetate, a ketimine, N-methyl morpholine, stannic chloride, butyl tin trichloride, bis(2-ethylhexyl)tin oxide, 1,3-diacetoxy tetrabutyl stannoxate, dibutyl dibutoxy tin, lead napthenate, bismuth trichloride, bismuth octonoate, tetra kis(2-ethylhexyl)titanate, tetrabutoxy titanium and mixtures of any of these.

20. The composition of claim 11, further comprising:
at least one of fibrous mats, tows, full-length fibers, non-woven structures, woven structures or random staple-fiber mixtures, glass fibers, calcium carbonate, fine cement, colloidal silica, carbon black, silica gel, gypsum, active carbon, silicones, fungistatic and bacteriostatic agents.

21. The composition of claim 11, wherein:
the solvent is selected from at least one of ethyl acetate, butyl acetate, amyl acetate, dipropyl acetate, cellosolve acetate, carbitol acetate, dimethylesters of dibasic acids, methyl ethyl ketone, methyl isobutyl ketone, cyclohexanone, dipropyl ether, dioxane, tetrahydrofuran, toluene, benzene, xylene, mineral oil, mineral spirits, diesel, bio-diesel, crude oil, methylene chloride, trichloroethylene, perchloroethylene, chlorobenzene, dichlorobenzene, nitoraliphatic solvents and combinations of these.

22. A method of treating a subterranean formation penetrated by a wellbore, the method comprising:
forming a treatment fluid containing:
at least one of 1) palmitic acid or its derivatives and 2) palm oil and at least one of an hydrolyzing or oxidizing agent to facilitate formation of palmitic acid or its derivatives; and
a source of a monovalent ion; and
introducing the treatment fluid into the wellbore.

23. The method of claim 22, wherein:
the monovalent ion is selected from Na, K and ammonium.

24. The method of claim 22, wherein:
palmitic acid derivative is at least one of an anhydride, an acyl halide, an amide or an alcohol.

25. The method of claim 22, further comprising:
introducing multivalent metal brine solution into the wellbore prior to introducing the treatment fluid.
